(19) United States
(12) Patent Application Publication
(10) Pub. No.: US 2013/0003144 A1
(43) Pub. Date: Jan. 3, 2013

(54) PORTABLE CCD CONTACT SCANNER

(76) Inventors: Dean Finnegan, Dublin, CA (US); Jerry Chung-Hung Chen, Castro Valley, CA (US)

(21) Appl. No.: 13/175,547

(22) Filed: Jul. 1, 2011

(51) Int. Cl. H04N 1/04

(52) U.S. Cl. 358/483

(57) ABSTRACT

A hand-held, portable, contact scanner using CCD scanning technology in conjunction with power regulation, noise reduction and image stitching. The scanner uses various movement tracking technologies to determine when the scanner is in contact with a document to be scanned. A dual roller system is used to effectively track motion of a contact scanner 100 across a target document. Alternatively, movement detection is performed by a reflected laser or infra-red (IR) output.

### BACKGROUND

Optical scanners are gaining importance as individuals and companies move to digitize various types of printed information. A portable or hand-held optical scanner is designed to be moved by hand across an object or document to be scanned. The image scanned can be stored on the device, in a portable media in the device, and/or transferred via a communication medium to computer. Commercial implementations of such devices typically use a CMOS image sensor as such sensors consume less power and are cheaper to manufacture.

### SUMMARY

A hand-held, portable, contact scanner which allows users to create a scanned image of a document or image by passing the scanner over the document or image at a rate selected by the user. CCD scanning technology is used in conjunction with power regulation, noise reduction and image stitching to provide a high resolution portable scanning device. The technology addresses problems which are inherent in use of CCD technology for portable scanning devices, including scanning noise and power noise. The scanner uses various movement tracking technologies to determine when the scanner is in contact with a document to be scanned. In one embodiment, a dual roller system is used to effectively track motion of a contact scanner 100 across a target document. Alternatively, movement detection is performed by a reflected laser or infra-red (IR) output. Improved direct detection of movement by the roller and hence measurement of the subject document allows a Contact Image Sensor (CIS) to more precisely provide feedback for adjustment of an RGB light source. This provides a fast response scanner. Power management techniques are utilized to reduce power supply noise resulting from use of the CCD sensor in a portable scanner.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a perspective view of a portable scanner in accordance with the present technology.

FIG. 2 depicts a top view of the portable scanner shown in FIG. 1.

FIG. 3 depicts a side view of the portable scanner shown in FIG. 1.

FIG. 4 depicts a first end view of the portable scanner shown in FIG. 1.

FIG. 5 depicts a partial cutaway view of the portable scanner shown in FIG. 1.

FIG. 6 depicts a partial cutaway, end view along line 6-6 in FIG. 3 of one embodiment of a portable scanner.

FIG. 7 depicts an end cutaway view along line 6-6 in FIG. 3 of an alternative embodiment of a portable scanner.

FIGS. 8 and 9 are partial perspective views of certain components of one embodiment of a portable scanner such as that shown in FIG. 1.

FIG. 10 is a block diagram of the operational components of a CCD scanning circuit in accordance with the principles of the present technology.

FIG. 11 is a block diagram of the components of a contact image sensor (CIS) module used in accordance with the present technology.

FIG. 12 is a block diagram of the CCD processing pipeline.

FIG. 13 is a flow chart illustrating one embodiment of a scanning process utilized with a roller-based scanner embodiment of a portable scanning device.

FIG. 14 is a flow chart illustrating the process for composing a scanned image after scanning using the method of FIG. 12.

FIG. 15 is a graphical depiction of the de-skew process.

### DETAILED DESCRIPTION

The present technology provides a hand-held, portable, contact scanner which allows users to create a scanned image of a document or image by passing the scanner over the document or image at a rate selected by the user. Technology is disclosed which implements a portable scanning device using CCD scanning technology in conjunction with power regulation, noise reduction and image stitching to provide a high resolution portable scanning device. The technology addresses problems which are inherent in use of CCD technology for portable scanning devices, including scanning noise and power noise. The scanner uses various movement tracking technologies to determine when the scanner is in contact with a document to be scanned. In one embodiment, a dual roller system is used to effectively track motion of a contact scanner 100 across a target document. Alternatively, movement detection is performed by a reflected laser or infra-red (IR) output. Improved direct detection of movement by the roller and hence measurement of the subject document allows a Contact Image Sensor (CIS) to more precisely provide feedback for adjustment of an RGB light source. This provides a fast response scanner. Power management techniques are utilized to reduce power supply noise resulting from use of the CCD sensor in a portable scanner.

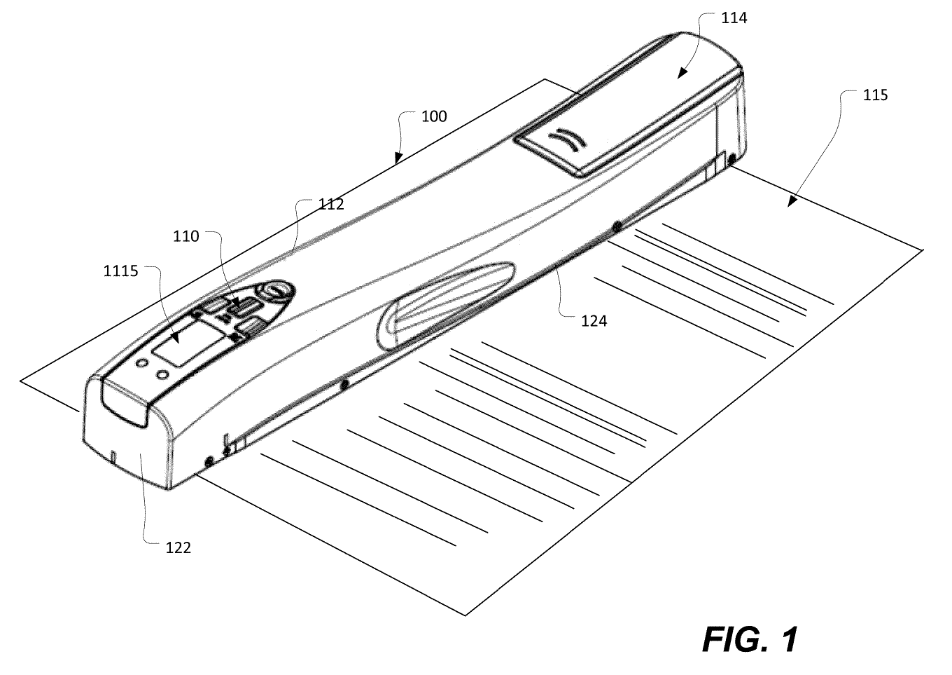

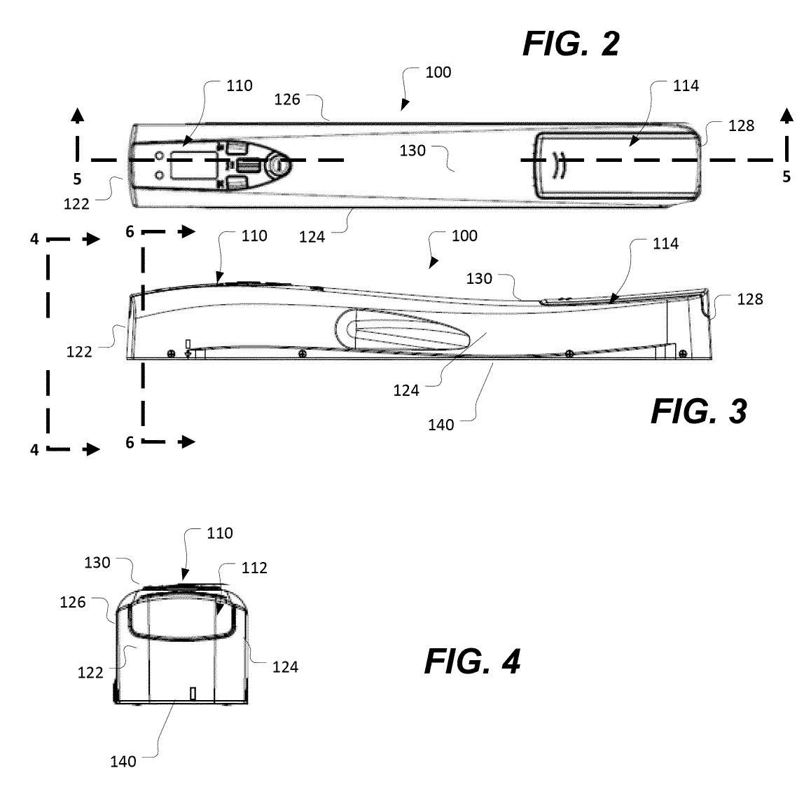

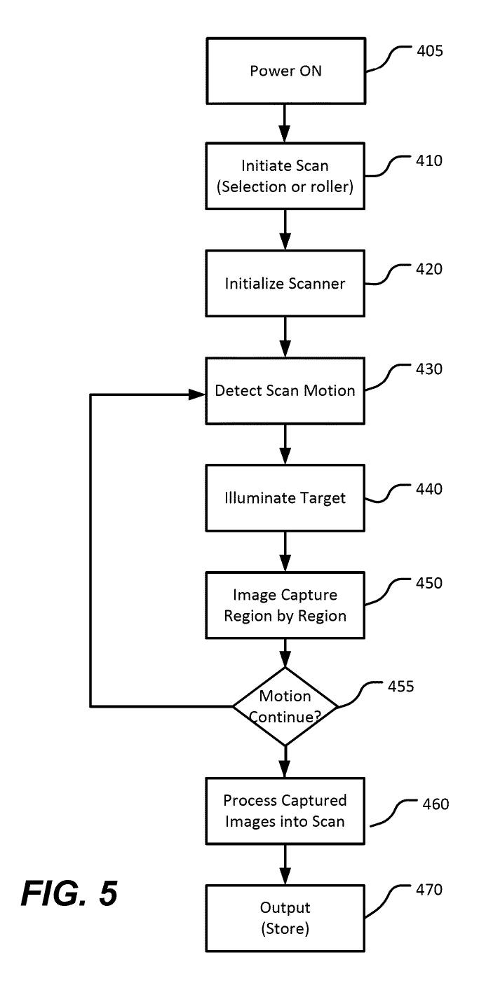

FIGS. 1 through 4 illustrate various views of a portable scanning device 100 in accordance with the present technology. Device 100 includes a plurality of components, described below, which are contained within a physical housing 112. The housing has a top 130, first side 124, second side 126, first end 122 and second end 128 defining the exterior of the portable scanning unit. Bottom 140 may be comprised of a portion of a CIS as described below, as well as one or more rollers which aid in allowing the device to be passed across a document when scanning. The housing includes a sliding opening 114 which is suitable to install a power source such as a battery within the housing. The battery may be placed as shown in FIG. 5. The housing may also include a control panel 110 to implement various direct functions under the control of a user as described herein.

FIG. 5 illustrates a general method for operating a scanner in accordance with the technology disclosed herein. Referring to FIG. 5 and with reference to FIGS. 1-4, at step 410, a scan is initiated after the unit, is powered on at 405. The scan may be initiated by a user selecting a specific switch on the control panel 110 to initiate a scan operation, by detecting motion of the scanner across a target document such as by detecting motion of a roller, or using another detection mechanism such as an IR detector or laser detector as described below. Scan initiation at 410 begins the image capture process utilizing the CIS. At step 420, the scanner is initialized by ensuring that the components required for scanning have sufficient power to begin operation, clearing all memory buffers and setting the initial line of the scanned image for processing. At step 430, motion of the scan is detected as the device is moved across a target document. The scan may be detected by scanning motion of the rollers or an alternative motion detection mechanism as described below. As discussed below, various embodiments of motion detection to determine whether a scan has begun are described herein. When motion is detected at 430, the target is illuminated at 440 using, for example, LED lighting, and an image capture process begins at 450. The image capture process includes capturing an image of the CCD array block over the motion of the scanner, block by block. The scanning process continues until motion is no longer detected at 455. This indicates that the scanning of the target document has concluded. While scanning is performed, or after scanning has completed, the captured blocks of the CCD array are processed into a completed scan at 460. Processing the scanning data may comprise, among other things, removing noise, joining lines of scanned data together, and other processing techniques to create an image of the document being scanned. At 470, the scan then is output to a source device in one or more different known storage formats.

Various embodiments of electro-mechanical systems may be utilized to detect scanning motion of the scanner 100 across a target document 115.

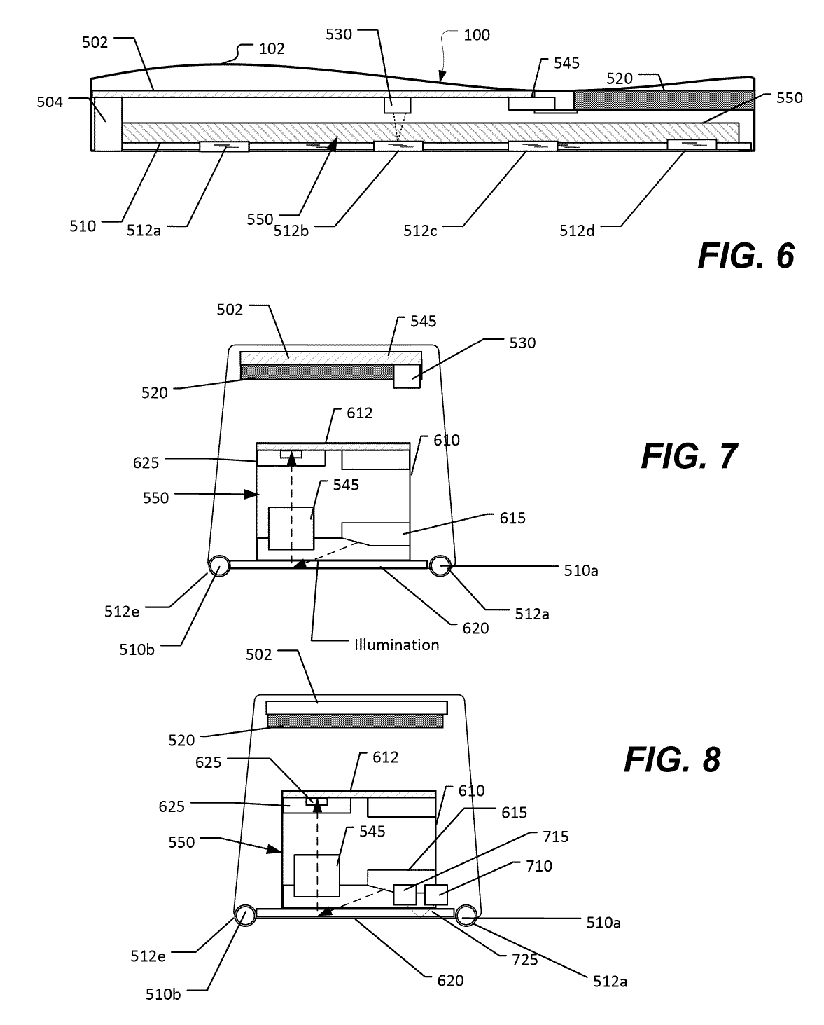

Internal components of the scanner 100 illustrated in FIGS. 6 through 9 include, among other things, a printed circuit board 502, an electrical connector 535 connecting the power source 520 to the components on the printed circuit board 502. Controllers and power sources on the PCB 502 are also connected to the CIS module 550 by a connector (not shown). A CIS module 550 which may include, among other components, an LED light source at 615, a gradient index lens 545 such as a SELFOC(R) lens manufactured by NSG America Inc, an optical sensor 625 such as a CCD array, all within a housing 610. A CIS suitable for use with the present technology is the M116-232C3 Contact Image Sensor available from CMOS Sensor Inc, Cupertino, Calif.

As illustrated in FIGS. 6 through 9, the scanner 100 may include multiple roller shafts 510 (510a, 510b), each of which having one or more rubber grommets or wheels 512 (512a-512e) attached thereto which rotate the roller shaft 510 as the bottom surface of the cover glass 620 is placed adjacent to a document 115 to scan. In various embodiments, a document 115 to be scanned is placed below the cover glass 620 and the device is slid across the document in a single direction. Operation of the components on the printed circuit board relative to performing a scan is described below.

Movement of the scanner 100 across the document 115 causes the shafts 510 to rotate which in the embodiments shown in FIGS. 1, 6, 7 and 9 is detected by electro mechanical components directed at the shafts or gears connected to the shafts 510. In the embodiment of FIG. 7, an IR or laser movement detector which illuminates the document 115 directly, is utilized.

Referring first to FIGS. 6 and 7, a first embodiment for detecting motion of the scanner across a target document includes an IR emitter/detector 530 aimed at one of the grommets 512b. The scanner 100 includes two sets of rollers 512a, 512b. Each roller 510a, 510b includes multiple rubber grommets, for example grommets 512a-512d (shown on shaft 510a), positioned at respectively equal positions along the length of the roller as illustrated in FIG. 6. More or fewer grommets 512 may be utilized. In one embodiment, direct detection of movement of the roller is accomplished by the use of an IR sensor 530 positioned above the roller 512b as shown in FIG. 6. The IR sensor includes an IR emitter and IR detector. An IR emitter outputs a beam onto rubber grommet 512b while the IR detector calculates motion and positions based on movement of the roller 512b which may be used to trigger and accomplish the scanning operation.

FIG. 8 illustrates an alternative electromechanical mechanism for detecting motion. In infrared laser or laser diode 710 is positioned adjacent to the cover glass 620 and illuminates the document surface while a photo detector detects motion based on movement relative to the document 115, rather than based on movement of the rollers. Receiver 715 detects a reflected image of the document 115. Emitter 710 sensor 715 may be any one of a number of light emitting diodes and photo diodes to detect movement relative to the underlying surface of the document

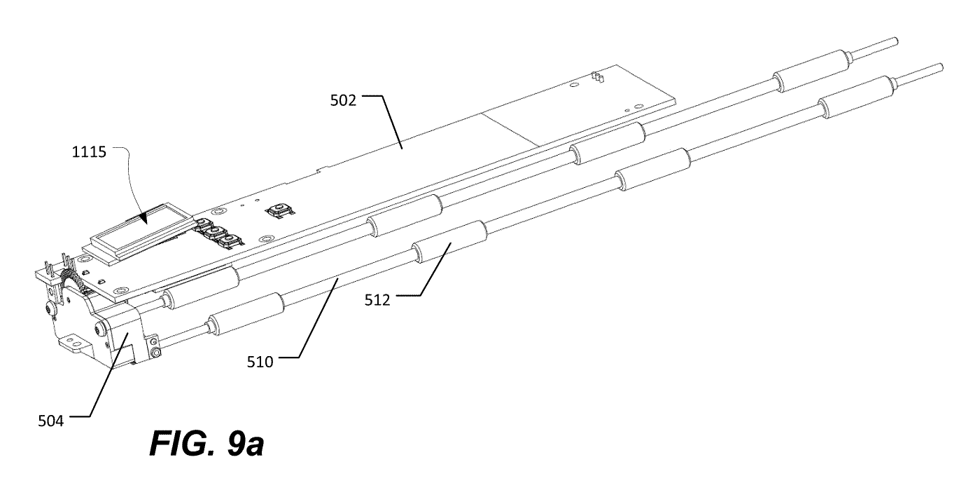

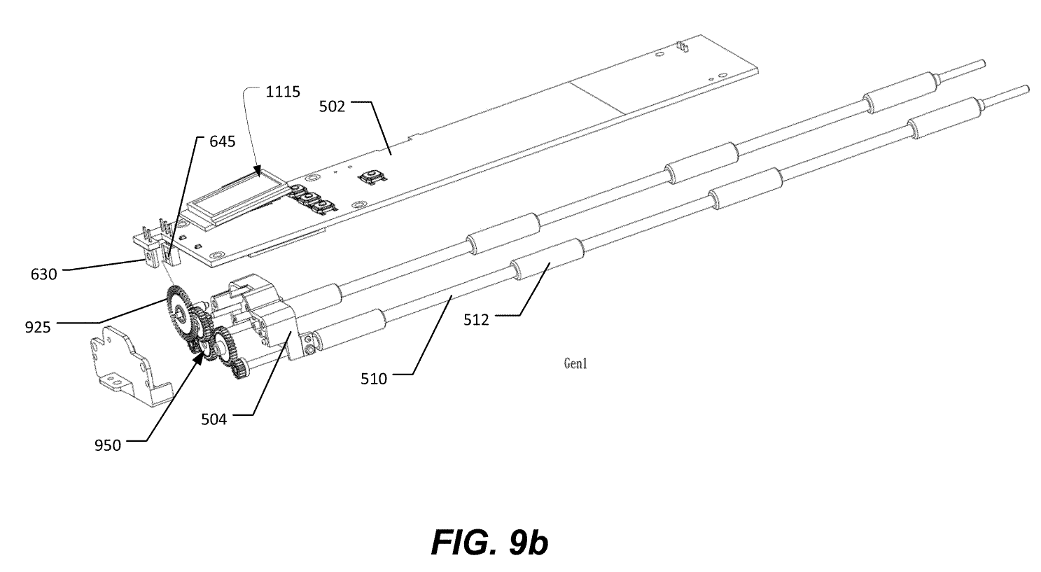

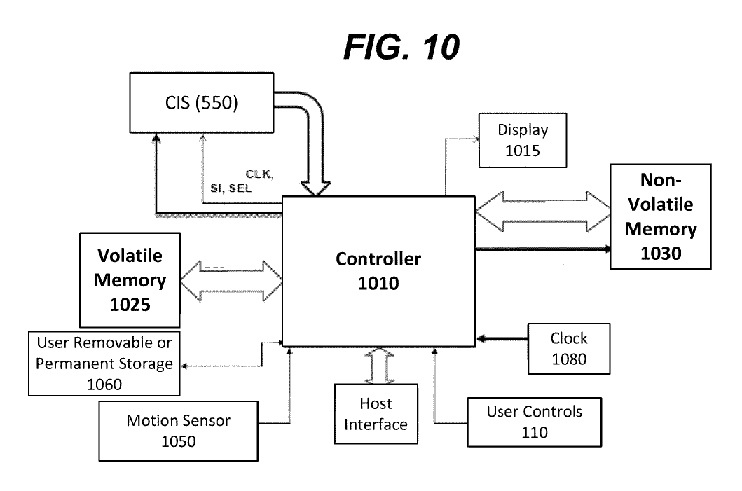

FIGS. 9a, 9b illustrate yet another electro mechanical embodiment for detecting motion of the scanner on a document 115 utilizing a drive gear assembly which synchronizes movement of the shafts 510 and allows movement tracking relative to the gear assembly. As illustrated in the exploded view in FIG. 9b, an infrared emitter 645 and infrared receiver 630 are positioned adjacent to a timing gear 925 which is part of a gear assembly 550. Two coupling gears are attached, one to each shaft 510. Rotation of the coupling gears is translated through a series of gears to the timing gear. The gear assembly is illustrated as having a particular arrangement, but any suitable arrangement for coupling the motion of the gears relative to the receiver 630 may be used. The teeth of timing gear 925 is positioned between the emitter 645 and the receptor 630. The IR sensor detects real movements at tiny revolutions to trigger the LED lighting condition and the CIS to start the scanning process.

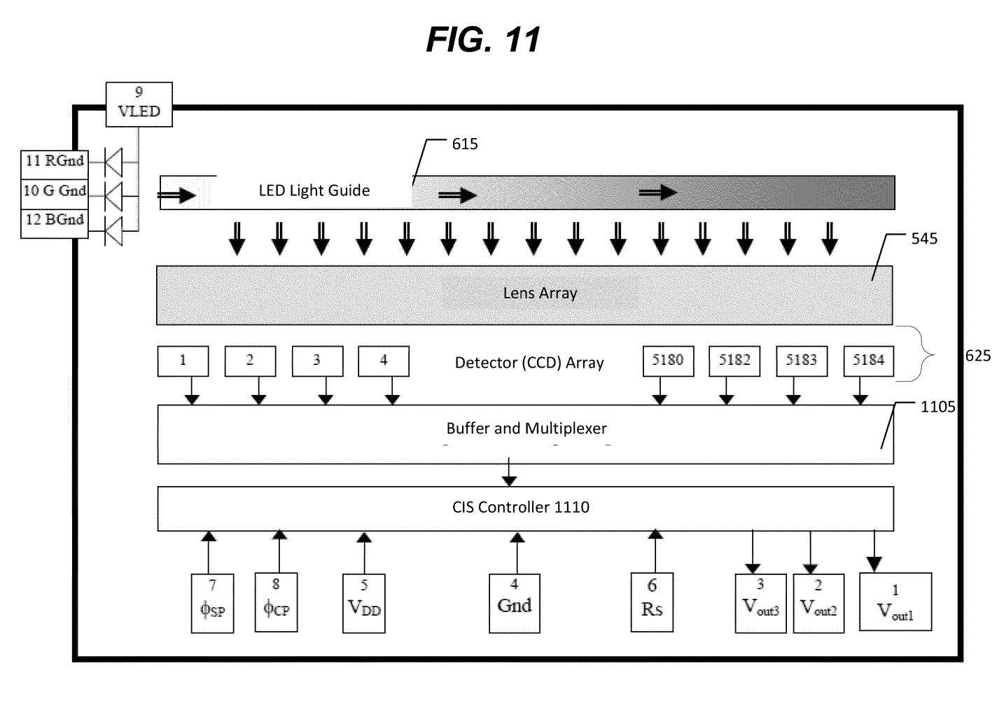

FIG. 10 is a block diagram illustrating the basic components of the scanner 100. Scanner 100 includes a CIS module 550 which includes a CCD module as described below and performs the image capture, functions. The CIS module is coupled to a controller 1010 and outputs a 3 component (RGB) signal to controller 1010 comprising the output of the pixel array used in the CCD module. Further information on the CIS module is provided below with respect to FIG. 11. On initiation of a scan, the controller instructs the CIS to illuminate the document using an LED control signal and includes clock and selection signals to enable other components of the CIS module.

Controller 1010 may comprise a processor such as and ARM9 microprocessor with dedicated memory management unit (MMU) & dedicated digital signal processing (DSP) components. The controller may be programmed with instructions capable of implementing the processes described herein. The system includes random access 1025 and non-volatile memory 1030. In one embodiment, volatile memory may comprise 256 megabytes of DDR random access memory accessible by a 16 bit bus, and non-volatile memory may comprise 16 megabytes of flash memory also addressable by a 16 bit bus. The controller 1010 and memory 1025 and 1030 may all be provided on PCB 502. User-accessible permanent or removable storage 1060 may be provided. In one embodiment, the user accessible storage may comprise a memory array housed in the scanner (on the PCB or elsewhere). In another embodiment, the user accessible memory may comprise a portable storage card inserted in a suitable card reader.

Motion sensor 1050 may comprise any of the motion sensing components described above or combinations of the above embodiments. A host interface 1090 provides a connection to a computer, tablet or other processing device, such as a smart phone. The host interface may comprise may comprise a cabled or wireless connection using any suitable transport medium or connection interface, such as a USB or micro USB interface. User controls 110 are input directly to controller 1010 and may comprise one or more buttons or dials to initiate and control scanning functions. A display 1015 is also provided to provide feedback to the user during the scanning process.

FIG. 11 is a block diagram of an exemplary CIS module utilized in the scanner 100. The CIS module includes an LED light guide 615, an optical lens 545, a 5184 element photo-detector array 625, a controller 1110 and a buffer/multiplexer 1105. In one embodiment, signals to and from controller 1010 may be provided as follows:

| Pin # | Symbol | Description |
|---|---|---|
| 1 | Vₒᵤₜ₁ | Analog output signal 1 |
| 2 | Vₒᵤₜ₂ | Analog output signal 2 |
| 3 | Vₒᵤₜ₃ | Analog output signal 3 |
| 4 | Gnd | Ground; 0 V |
| 5 | V_{DD} | power supply voltage; 3.3 V |
| 6 | Rs | Resolution select; Vdd = 300 dpi; Gnd = 600 dpi |
| 7 | φ_{SP} | Start pulse |
| 8 | φ_{CP} | Main clock pulse |
| 9 | VLED | Anode of LED light sources |
| 10 | GLED | Cathode of Green LED light source |
| 11 | GLED | Cathode of Red LED light source |
| 12 | GLED | Cathode of Blue LED light source |

The lens array 545 directs a detected image to a photo detector 625. The output of a photo detector 625 is input to a shift register multiplexing switch 1105. The imaging lens is commonly used as an objective lens for small diameter imaging systems where conventional lenses are not suitable due to size limitation. The lens is designed to gather light from an object and form an inverted image at the back surface of the lens.

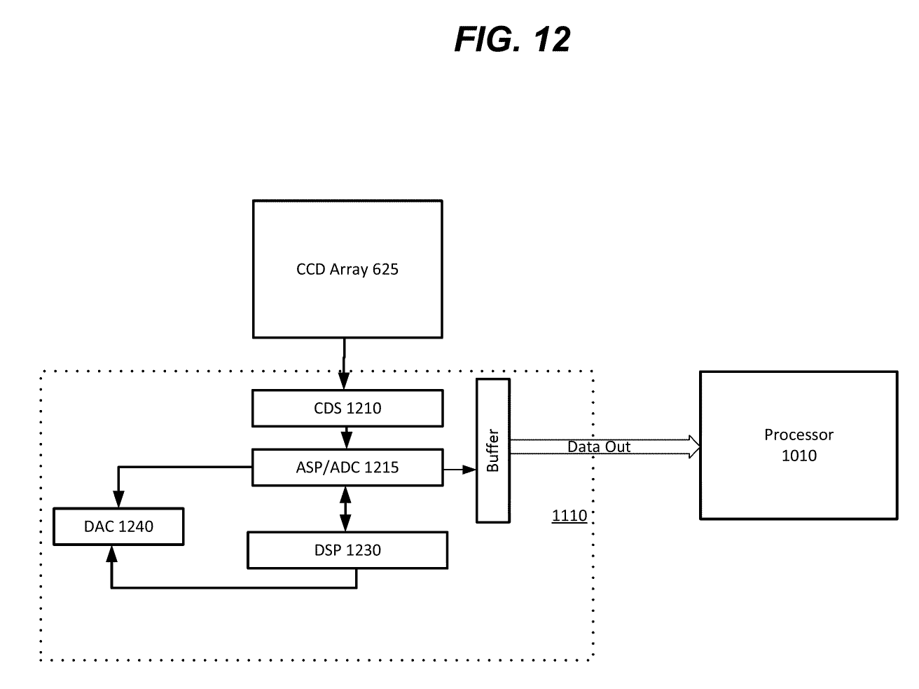

FIG. 12 is a block diagram of the exemplary control circuitry 1110 for reading the CCD array. The CCD array 625 may driven by a clock driver 1235 and be coupled to a unit for correlated double sampling 1210, a pipeline analog signal processor (ASP) and analog to digital converter (ADC) 1215, an digital signal processor 1230, a low pass filter 1245 and a digital to analog converter 1240. In general, CCD's output signal is served by an analog, signal-processing chain comprised of the CDS and ADC. All of the signal processing steps from the output of the CCD through the digital output of an A/D converter—can be accomplished with a single integrated circuit. A typical CCD output stage converts the charge of each pixel (picture element) to a voltage via a sense capacitor. At the start of pixel period, the voltage on the capacitor is reset to the reference level. The amount of light sensed by pixel is measured by the difference between the reference and data voltage levels. The clock driver is used to time-shift signal processing. The low-pass filter removes noise before sending data to processor 1010.

Accurately recovering and digitizing the CCD signal requires several operations, including correlated double sampling (CDS) and dc restoration (clamping), gain, offset, and A/D conversion. Correlated double sampling (CDS) calculates the difference between the reference and data levels of CCD signal, and it reduces some of the noise components in the CCD signal. One implementation of CDS uses two sample-and-hold amplifiers (SHAs) and a difference amplifier, one of many possible topologies. By taking two samples of the CCD signal and subtracting them, any noise source that is correlated to the two samples will be removed. Slowly varying noise source that is not correlated will be reduced in magnitude. Noise introduced in the output stage of the CCD consists primarily of kT/C noise from the charge-sensing node, and 1/f and white noise from the output amplifier. The kT/C noise from the reset switch's ON-resistance is sampled on the sense node, where it remains until the next pixel. It will be present during both to reference and data levels, so it is correlated within one pixel period and will be moved by the CDS. The CDS will also attenuate the 1/f noise from the output amplifier, because the frequency response of the CDS falls off with decreasing frequency. Low frequency noise introduced prior to the CDS from power supplies and by temperature drifts will also be attenuated by the CDS.

In a further unique aspect, appropriate power routing is implemented for high quality imaging. In one embodiment consists two power supplies, AVdd and DVdd, respectively are provided to feed analog and digital circuits. Although they are nominally of the same value, and are tied together off-chip so that the chip operates from a single power supply, separate pads with different power supply isolation circuits are provided for the two, primarily to prevent clocking noise from corrupting internal analog signals. For the same reason, the digital logic drivers for SEL and RST signals are driven off A Vdd, although they are really part of the digital block. This is particularly important since analog pixel sampling lasts more than one clock cycle, while the digital logic changes state in every clock cycle.

Vdd bus routing plays a critical role due to potentially large resistive drops. Although overall power dissipation in CMOS imagers is quite small, being ˜10-20 mW for video-rate operation, instantaneous power draw can be large, since all pixels in a given row are activated simultaneously. For a megapixel format imager, the total current draw during pixel sampling and reset can be easily 20 rnA, although each pixel draws only 20 microamp current. The voltage drop across the power bus (i.e. maximum variation in the power supply voltage from one pixel to another) is given by:

$${V}_{drop} = \frac{1}{2} \cdot {N}^{2} \cdot {I}_{pix} \cdot {Ω}_{sq} \frac{{L}_{pix}}{{W}_{line}} \qquad ( 1 )$$

where N is the number of pixels per row served by the power bus of width Wline, Ipix is the current flow through each pixel of length Lpix, and Qsq is the line resistance per square. In a CMOS imaging device, considering the fact that the random noise in a high performance CMOS imager is around 0.3-0.4 mV r.m.s., it is desirable to have power supply matching between columns (i.e. V drop) ˜1 mV. This value can be utilized for a CCD imager as well. Assuming that the power is brought to a mega-pixel pixel array from one edge, N=1 024, and the line width needed to achieve V drop ˜1 mV drop is 5.2 rum for a pixel pitch of 10 micrometer. A similar sized bus is needed for the ground routing as well.

In accordance with the foregoing, in the present technology alternate power routing is utilized. Equation (1) indicates that the voltage drop can be significantly reduced if the number of pixels served by a power bus is reduced (due to the square law dependence). Hence, a tree-topology for power routing is utilized wherein the main power supply is brought from the center, and is split into equal sized branches, which are then sub-divided in the same fashion, with the width of each branch being scaled down at every stage. In this way, total width of the power bus can be reduced at the expense of somewhat increased total voltage drop across the power bus, while keeping the relative drop from one column to another small.

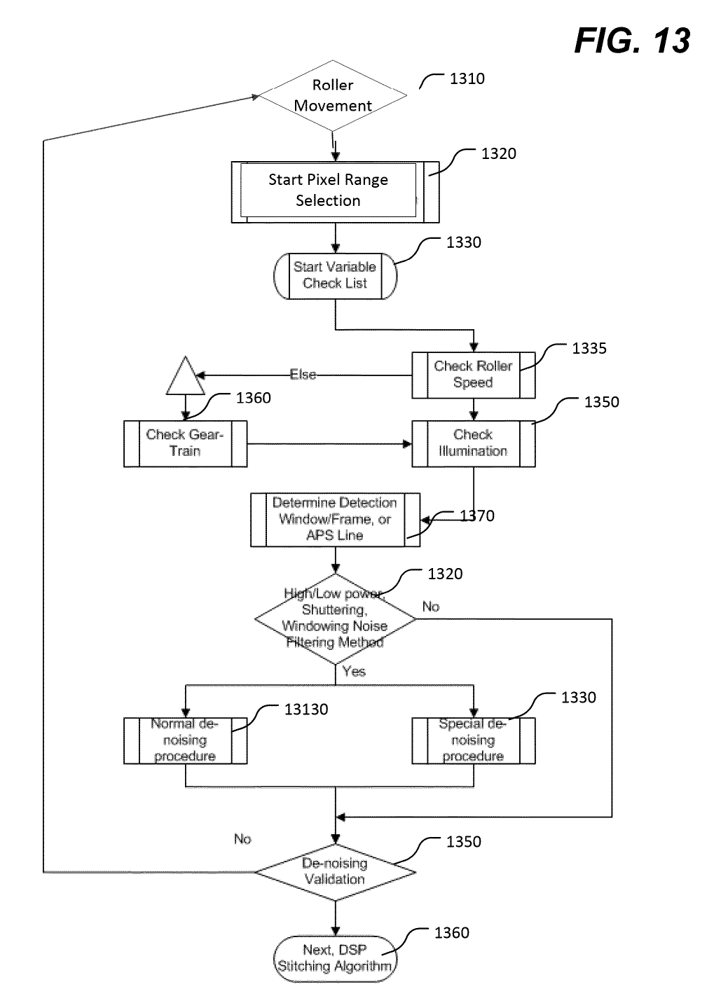

FIG. 13 is a flow chart illustrating the process performed during one embodiment of a scan. The scan starts at block 1310 when roller movement is detected. The movement of the rollers is checked at 1320. At 1330, a variable checklist is performed. The variable checklist may include determining that all initial values for capture in the CCD array are set to threshold levels. At 1335, roller speed is determined. If Roller speed cannot be determined, a gear train sensor may be utilized to determine roller movement at 1360. Next, LED light illumination is checked at 1350. At 1370, the initial line in the scan of the document is determined. This can be performed by determining the initial window or frame or the APS line of the document. At 1375, a determination is made as to whether noise resulting from high or low power, shuttering or winding noise is present in the scan and if so, one of two de-noising algorithms is used. Noise detection is performed by a Poisson probability sampling algorithm in accordance with known techniques. For saturations issues and rolling shuttering issues, and non-antiblooming gate issues, normal de-noising procedures 1380 may be used. Non-AntiBlooming Gate (NABG) circuits may be provided as part of active pixel area a linear DSP in response to light array. It generates a charge that accurately reflects the amount of light striking each pixel involving measurement of incoming light (photometry). A special de-noising method 1385 has several voltage grid to filter and repeat procedures to ensure sharpness and color are retain after filtering and is disclosed in 0-7695-2875-9/07, Zhang Lina, Wu Xiaoqinb, Hu Xueyoua., Research on CCD Noise Signal Processing Hefei University, Hefei, P. R. China. IEEE/ICNC 2007, hereby fully incorporated by reference. If these methods are not required, then a de-noising evaluation is performed at 1390 and at 1395. Digital signal processing and stitching may be performed.

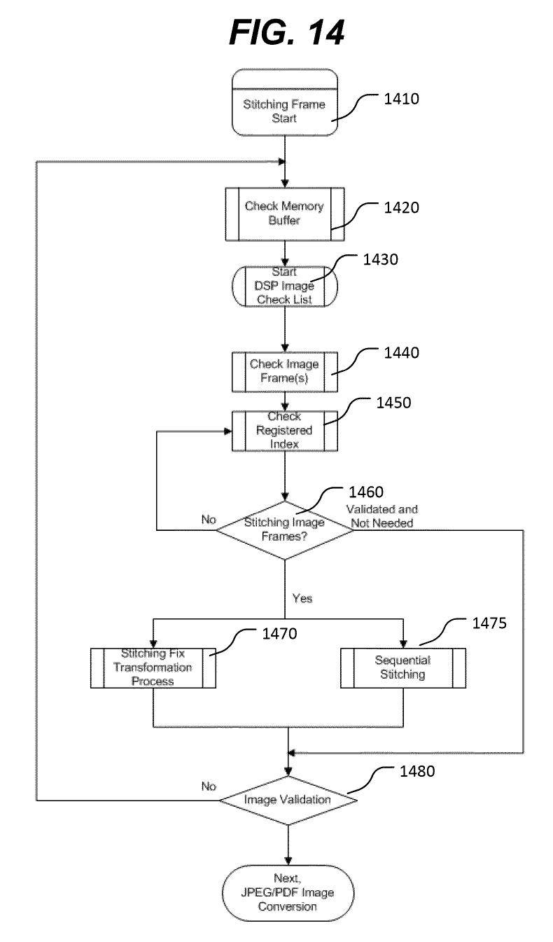

FIG. 14 illustrates a stitching algorithm performed in accordance with the present technology. A CCD imaging array has the ability to start and stop exposure arbitrarily. It handles the image distortion better, using less transistors per pixel per image sensor. Its faster electronic shuttering with little fill-factor comprised on each captured image—the imager uniformly fills the electronic shuttering placement on active pixel (matrix) area in real-time and directly converts to digital signal, where as CMOS technique will have to process this in a non-uniform shutter, rolling shutter or uniform synchronous shutter as known as non-rolling shutter.

In order to provide a cohesive image, stitching of the successive frames of the CCD is utilized. As illustrated in FIG. 14, stitching is performed on a frame-by-frame basis. At 1410 at the first frame, a memory buffer is cleared at 1420 and a DSP image checklist is performed as described below. A check is made at 1440 for the existence of a number of frames to begin the stitching process and at 1450, the registered index is checked. If there are multiple frames at 1440, stitching may be required. At 1450, the registered index determines a frame index as recorded by the CCD array relative to other frames known to be in the memory buffer. A determination is made as to whether stitching is required at 1460. If non-successive frames are present or stitching is not required, the registered index is re-checked until stitching may be required. If stitching is required at 1460, sequential stitching performed in the following manner:

```
For each frame
      Build DPI [# Build the Memory buffer for stitching Defined
      Patch/Pixel Index (DPII)#]
            Find affected SBIs [# Find Stitching Block per queue #]
            For each segment S of DPI
                  For each pixel P of segment S
                  For each SBI(stitching block index) in SBIs
            (stitching block segment “s”)
                          Set P′ = P warped to SBI [# Stitching
                          Block per queue #]
                          If P outside SBI next SBI
                          If P′ > P next P
                          If P′ < P, P′ = P, next P
                          If P′ is empty and no AP
                              AP =(SBI, P′), next SBI
                  End for each SBI
            If AP commit AP, next P
                  Create new SBI, assign P
            For each P = SFPI in FPIs, P″ = P FixPatchAlgorithm
      to(SBI) (Apply De-skew Algorithm)
                  End for each pixel
            End for each segment, Validate Segment / Pixel
End for each frame, Validate Frame & Tag(DPI)
```

As noted above, stitching is performed on a frame by frame bases over a two-dimensional section of the image data. First, stitching blocks (SB) requiring stitching are found by finding start pixels for each block. For each potential stitching block, and for each pixel P in each segment of a stitching block, a normalized pixel value P is compared to an adjacent normalized pixel p′ in the stitching block. In this case the normalized comparison is between the absolute black value of the pixel in each block. This determines the black/white leading left edge of the scan.

Next a stitching fix is performed at 1470. This is reflected in the last line of the pseudo code above at:

For each P=SFPI in FPIs, P″=P FixPatchAlgorithm to(SBI) (where SFPI—Skew-correction Filter Pass Index).

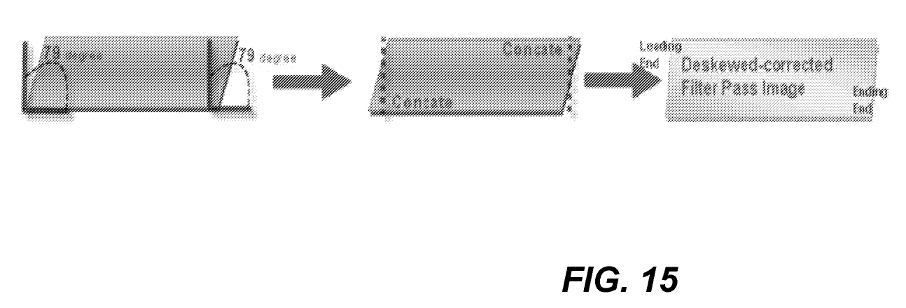

This is illustrated in FIG. 15. The fix comprises a repair process which may occur after sequential stitching process to correct any abnormalities in the image output. This “de-skew” correction is on the scanned image on a non-perpendicular (trapezoid shape) leading and ending edges. This method can correct up to 0.25 mm skewed front and back edges of the image before stitching.

After image validation at 1480, image treatment can be done. Image treatment may include cropping; red eye removal, artistic treatments such as retro-Image and picture bordering treatments, OCR indexing, color inversion and the like. Stitching techniques suitable for use in the present technology described in MSR-TR-2004-92, Image Alignment and Stitching: tutorial, Richard Szeliski. Microsoft Research, Microsoft Corp, 2006 MS Technical Report; CESCG-2006, Piotr Ostiak, Institute of Computer Graphics and Multimedia Systems. Technical University of Szczecin, Poland. ACM/IEEE 2007 hereby fully incorporated by reference. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A portable contact image scanner, comprising:
a housing;
a contact image sensor including charge-coupled device (CCD) array, an LED illumination source and optics directing LED illumination to a target image mounted in the housing;
a processing device including instructions providing a de-noising algorithm and an image stitching algorithm, the processing device mounted on a printed circuit board within the housing;
a motion detector mounted in the housing comprising a photo detector and an illumination source positioned to detect the motion of the target document relative to the image scanner;
a power source coupled to the contact image sensor, printed circuit board and motion detector;
wherein the printed circuit board includes a power routing structure for a series of power conductors on the printed circuit board which reduces power noise effects on the CCD output.

2. The contact image scanner of claim 1 wherein the motion detector comprises at least two rollers in contact with the document, and the illumination source is directed at one of said at least two rollers, and the photo detector senses reflected illumination from the illumination source on the roller to determine motion of the housing relative to the document.

3. The contact image scanner of claim 1 wherein the motion detector comprises at least two rollers in contact with the document, and the illumination source is directed the document, and the photo detector senses reflected illumination from the illumination source on the document to determine motion of the housing relative to the document.

4. The contact image scanner of claim 1 wherein the motion detector comprises at least two rollers in contact with the document and a gear assembly coupled to the rollers, and the illumination source is directed the at least one gear in the assembly, and the photo detector senses movement of the gear gating exposure of the illumination source through the gear to determine motion of the housing relative to the document.

5. The contact image scanner of claim 1 wherein the printed circuit board includes a tree-topology for power routing wherein the main power source is brought from a center of the PCB, and is split into equal sized branches, which are then sub-divided in the same fashion, with the width of each branch being scaled down at every stage.

6. The contact image scanner of claim 1 wherein the instructions include an image stitching algorithm and an image stitching fix algorithm.

7. A portable contact image scanner, comprising:
a scanner housing including a printed circuit board;
a charge-coupled device (CCD) coupled to an array controller, the controller coupled to an LED illumination source,
optics directing LED illumination to a target document, the optics mounted in the scanner housing;
a processing device receiving an output from the CCD and including instructions providing a de-noising algorithm and an image stitching algorithm, the processing device mounted on the printed circuit board within the housing;
at least two rollers contacting the target document;
a motion detector mounted in the housing comprising a photo detector and an illumination source positioned to detect the motion of the target document relative to the image scanner;
a power source coupled to the CCD, printed circuit board and motion detector;
wherein the printed circuit board includes a power routing structure for a series of power conductors on the printed circuit board which reduces power noise effects on the CCD output.

8. The contact image scanner of claim 7 wherein the printed circuit board includes a tree-topology for power routing wherein the main power source is brought from a center of the PCB, and is split into equal sized branches, which are then sub-divided in the same fashion, with the width of each branch being scaled down at every stage.

9. The contact image scanner of claim 8 wherein the instructions include an image stitching algorithm and an image stitching fix algorithm.

10. The contact image scanner of claim 9 wherein the motion detector comprises at least two rollers in contact with the document, and the illumination source is directed at one of said at least two rollers, and the photo detector senses reflected illumination from the illumination source on the roller to determine motion of the housing relative to the document.

11. The contact image scanner of claim 9 wherein the motion detector comprises at least two rollers in contact with the document, and the illumination source is directed the document, and the photo detector senses reflected illumination from the illumination source on the document to determine motion of the housing relative to the document.

12. The contact image scanner of claim 9 wherein the motion detector comprises at least two rollers in contact with the document and a gear assembly coupled to the rollers, and the illumination source is directed the at least one gear in the assembly, and the photo detector senses movement of the gear gating exposure of the illumination source through the gear to determine motion of the housing relative to the document.
